(19) United States
(12) Patent Application Publication
(10) Pub. No.: US 2009/0013407 A1
(43) Pub. Date: Jan. 8, 2009

(54) INTRUSION DETECTION SYSTEM/INTRUSION PREVENTION SYSTEM WITH ENHANCED PERFORMANCE

(76) Inventors: Brad Doctor, Golden, CO (US); James Brown, Aurora, CO (US)

Correspondence Address: MARSH, FISCHMANN & BREYFOGLE LLP, 8055 East Tufts Avenue, Suite 450, Denver, CO, 80237, US

(21) Appl. No.: 12/031,513

(22) Filed: Feb. 14, 2008

Related U.S. Application Data
(60) Provisional application No. 60/889,888, filed on Feb. 14, 2007.

(51) Int. Cl. G06F 21/00

(52) U.S. Cl. 726/23

(57) ABSTRACT

A traffic inspection and filtering system (100) monitors traffic across a protected interface. In the case of monitoring incoming traffic, the incoming packets (102) are directed via a mandatory path (104) to a packet capture process (106) associated with a kernel (110) of an operating system. The packets are then stored in shared memory (112) of the kernel (112) for access by a user space application (108) that makes a filtering decision without requiring copying of the packet to user space and back.

### CROSS-REFERENCE TO RELATED APPLICATION

This application claims priority under 35 U.S.C. 119 to U.S. Provisional Application No. 60/889,888, entitled, “Intrusion Detection System/Intrusion Prevention System With Enhanced Performance,” filed on Feb. 14, 2007, the contents of which are incorporated herein as if set forth in full.

### FIELD OF INVENTION

The present invention relates to network monitoring systems, including traffic analysis and filtering system such as intrusion detection systems (IDSs) and intrusion prevention systems (IPSs). In particular, the invention relates to a reliable and cost effective approach for achieving high speed, e.g., at least 2.0 Gbps or multi-gig, throughput in connection with state of the art network monitoring systems. This provides the opportunity to implement IDS and IPS functionality using PC class hardware and operating systems at the election of network administrators. Other network monitoring systems such as traffic analysis (without associated filtering) and network use policy enforcement systems can also be implemented in accordance with the invention.

### BACKGROUND

A variety of network monitoring applications are employed by network administrators or others, and it is anticipated that this will be an area of continued development. Typically, these applications monitor traffic across one or more network interfaces of interest on a packet-by-packet basis, with respect to a series of packets, or otherwise at a fine level of granularity in relation to deployed data rates. These applications may simply inspect traffic or may be involved in actively filtering traffic. For example, an inspection application may inspect packets so as to report traffic levels or levels of different kinds of traffic or activities. The results may be displayed on a dashboard or similar display monitored by a network administrator. A filtering application may analyze packets and then selectively filter the packets based on the analysis, e.g., pass, drop or modify packets. In any event, these applications generally involve real-time inspection of packets or groups of packets at an interface of interest by a user space application.

The case of IDS and IPS applications is illustrative. A number of strategies have been developed to detect likely intrusion attempts or events, such as worms, Trojans, spyware, port scans, DoS and DDoS attacks, server export attempts and viruses. These strategies generally involve, at least in part, real-time monitoring of traffic across protected interfaces. Conventional IDSs and IPSs have struggled to keep up with deployed data rates. In this regard, multi-gig processing speeds are now desirable to effectively implement IDS and IPS functionality in some environments.

Proposals to provide the desired processing speed reflect the perception that current off the shelf hardware and software cannot provide the desired speed or are unreliable. In particular, such proposals have included purpose built appliances with ASICs network processing hardware acceleration cards and/or other custom hardware upgrades. However, such approaches are expensive, inflexible and may not scale well to meet changing processing requirements.

### SUMMARY

The present invention is directed to providing improved packet throughput for network monitoring systems involving packet inspection analysis using PC class hardware and operating systems. That is, the invention enables enhanced throughput rates using current off the shelf (COTS) hardware (e.g., as available in retail PC without custom hardware upgrades) and PC class operating systems such as Linux, Microsoft Windows or MAC OS X, As noted above, there has been a perception among many developers that PC class hardware and operating systems are incapable of providing the desired speed for network monitoring including IDS and IPS processing due to, for example, slow PC busses, an inefficient interface between the CPU and core system memory, insufficient CPU power and limited operating system capabilities. The present inventors have recognized that existing PC class hardware and software can reliably achieve multi-gig speeds by more efficiently handling traffic.

In particular, by implementing kernel extensions that are specific to the packet inspection task, multi-gig speeds can be achieved. For example, conventional IDS and IPS approaches in this regard have generally made at least four copies of each packet for inspection by the user space IDS/IPS process. Specifically, an incoming packet from the network interface card (NIC) is copied to provide a new packet. The new packet is then copied to user space for access by the IDS/IPS process. The inspection process is then implemented, and the resulting inspected packet is then copied back from user space. Finally, the original packet is copied back to the network stack.

The present invention allows for in-line packet inspection processing while only making a single copy of the packet under analysis. In particular, a packet capture process can be modified such that a custom kernel extension is the first call a device driver makes into the kernel. The packet is then copied into a designated, shared memory segment that is mapped to user space, or otherwise made available to applications in user space. The IDS/IPS engine can then poll the shared memory space, inspect the packet and notify the kernel that the packet was inspected. The custom kernel extension then inserts the packet back into the network stack. By virtue of the enhanced efficiency, fast packet inspection processing including IDS/IPS processing is accommodated in-line and the system is scalable with faster hardware, e.g., multi-core processors such as quad-core CPUSs and other multi-core systems in development.

In accordance with one aspect of the present invention, a method and apparatus (“utility”) is provided for in-line analysis of packets by a user space process such as an IDS, an IPS or a network policy enforcement process. The utility involves establishing a mandatory path for packet transmission in relation to an interface of a network and monitoring the path for a packet or series of packets of interest for processing by the user space process. For example, the mandatory path may be implemented by the packet capture mechanism of an operating system (e.g., Linux). Upon identification of a packet of interest, the user space process is employed to perform an analysis on the packet and provide a substantially real-time output that is dependent on the results of the analysis. For example, the analysis may result in a pass/no pass (PNP) determination that is reported to the kernel to implement a filtering function. In this regard, a conventional IDS such as Snort, an IPS, an application executing a company network use policy, or other application/project involving a PNP determination may be employed. The packet capture process is then operated to selectively allow or disallow the packet to pass the protected interface of the network based on the PNP determination. Alternatively, the output may result in modifying the contents of selected packets, or reporting traffic levels/composition. It will be appreciated that the references above to particular applications or processes such as Linux Snort and the like are merely for purposes of illustration, and the invention is not limited to any such particular processes or contexts.

In accordance with another aspect of the present invention, a utility allows a user space network monitoring application to access a shared kernel memory segment so as to enhance data throughput. The utility involves allocating a shared kernel memory segment, e.g., a ring buffer or other designated memory such as hardware-provided DMA, for access by the user space application and using the allocated shared kernel memory segment to store packets for processing by the user space application. The user space application is operated to perform an analysis on at least one packet in the shared kernel memory segment. The kernel is then operated to process the packet in a manner dependent on a result of the analysis.

In one implementation, the step of allocating involves receiving a request, from the user space application via an API, regarding allocation of the shared kernel memory segment and allocating the shared kernel memory segment in response to the request. Once the memory segment has been allocated, a network interface is monitored such that incoming and/or outgoing packets can be directed to the shared kernel memory segment. The user space application can then periodically poll the shared memory segment for new data and perform an analysis on the new data. For example, the analysis may involve a PNP determination. Based on the result of the PNP determination, the packet can either be passed through the network stack or a portion of the shared memory associated with the data can be de-allocated.

Alternatively or additionally, the analysis may involve identifying content subject to a rule regarding transmission across a monitored interface. For example, the new data in the shared memory may be analyzed to identify a predetermined pattern corresponding to, e.g., a social security number or other data deemed sensitive according to a network policy. When such information is identified, the relevant data portion may be removed or replaced. For example, an API call may be used to notify the kernel that packets will potentially be filtered, and/or modified, not just viewed. In this regard, when the user space application determines that a packet is fragmented, a partial match-and-replace can be formed over multiple data packets. The user space application may perform both a PNP analysis and a detect-and-remove/replace analysis on the same set of data. By virtue of the noted shared memory implementation, the data can be analyzed and otherwise processed efficiently, thereby enhancing throughput at the monitored interface.

In accordance with a still further aspect of the present invention, a high throughput traffic inspection system is implemented using PC class hardware and a PC class operating system, thus eliminating the need for purpose built hardware and custom software for many environments. An associated process involves: establishing a network connection with a computer having PC class hardware and a PC class operating system including a PC class kernel; and operating the computer to inspect traffic, across an interface between the computer and the network, on a packet-by-packet basis. The application may further implement a packet filtering determination with respect to the packets. The step of operating involves inspecting the traffic at a rate of at least about 200 Mbps. More preferably, the traffic is filtered at a rate of at least about 1 Gbps. In one implementation, a filtering rate of at least about 2.33 Gbps has been achieved.

### BRIEF DESCRIPTION OF THE DRAWINGS

For a more complete understanding of the present invention and further advantages thereof, reference is now made to the following detailed description taken in conjunction with the drawings in which:

FIG. 1 illustrates a traffic inspection and filtering system in accordance with the present invention; and

FIG. 2 illustrates a traffic inspection and filtering process in accordance with the present invention.

### DETAILED DESCRIPTION

The present invention is directed to a method and apparatus for improving the throughput of a traffic analysis application involving packet inspection using PC class hardware and a PC class operating system. In the following discussion, the invention is set forth in the context of a specific implementation for enhancing efficiency of certain inspection and filtering applications by eliminating the need to copy packets from kernel memory to user space memory and back to execute the filtering application functionality. While specific examples in this regard are set forth below, it will be appreciated that various aspects of the invention are not limited to these examples but are more broadly applicable with respect to a variety of network monitoring applications.

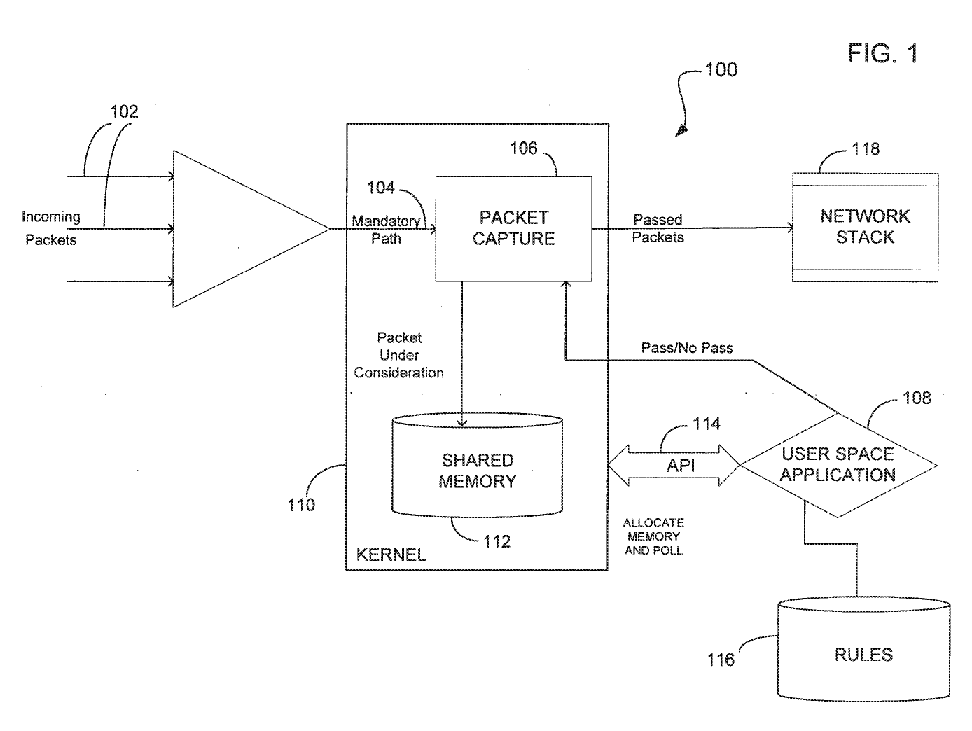

FIG. 1 illustrates a traffic inspection and filtering system 100 in accordance with the present invention. The system 100 monitors traffic across a protected interface, for example, between a computer and a network such as a local area network. In such a context, incoming packets 102 are generally received from a network interface card. The incoming packets 102 are directed via a mandatory path 104 to a packet capture process 106 associated with a kernel of an operating system as will be described below. The packets are then stored in shared memory 112 of a kernel 110 for access by a user space application 108.

The user space application 108 may be any application involved in monitoring and filtering traffic across a protected interface. In this regard, incoming and/or outgoing traffic may be monitored. Some examples of applications that may be utilized include intrusion detection systems, intrusion prevention systems, entity policy enforcement systems (e.g., for preventing or restricting the transmission or receipt of personal, proprietary, competitive or otherwise sensitive information), etc. in this regard, the application may access rules 116 for policing the traffic across the protected interface. Such rules may identify potential malware, effect entity policies or otherwise provide a basis for making a decision as to how to process a packet under consideration.

For example, the rules may implement a filtering determination. Thus, a packet that is suspicious based on analysis by the application 108 may be dropped (deleted or allowed to expire from a buffer or other memory), passed unchanged to the network stack 118 in the case of incoming traffic, or modified prior to passage to the network stack 118. The packet may be modified, for example, to protect sensitive information. Thus, personal information such as a social security number may be deleted from the payload of a packet or location information (e.g., a geocode) may be generalized (e.g., rendered less specific by reducing the number of significant digits) to respect privacy rules.

In the context of the present invention, this analysis and filtering can be executed with a minimum amount of packet copying and transfers, thereby improving processing efficiency and increasing throughput rates for given hardware and a given operating system/kernel. Conventionally, such applications have required that the packet first be copied into kernel space memory and then into user space memory for access by the application. The application would then process the packet and transfer the processed packet back to the kernel space memory, which would then result in the packet being stopped, passed to the network stack or modified and pass to the network stack as appropriate. The result was that PC class hardware and software were viewed as being insufficient to keep up with deployed data rates as discussed above.

In the illustrated system 100, a packet under consideration is stored in designated shared memory 112 of the kernel 110. An API 114 allows the user space application to establish and access the shared memory 112 so as to execute an analysis thereof. Based on the analysis, the application can then modify the packet stored in the shared memory 112 of the kernel 11I or direct the packet capture process 106 to pass or not pass the packet, thereby significantly reducing the number of copies of the packet that re required to execute the filtering function and improving throughput rates.

Specifically, the illustrated system 100 can achieve data throughput rates of at least about 200 Mbps using PC class hardware and operating systems, thereby exceeding conventional performance in such environments and satisfying the requirements of many networks previously thought to require certain hardware/software solutions. Testing has shown that the system 100 can achieve throughput rates of 1 Gbps using PC class hardware and a PC class operating system meeting a common performance goal for high performance networks. Moreover, the illustrated architecture can be implemented with shared memory for multiple application instances so as to support multi-core, e.g. quad core, scaling. In one implementation, the illustrated system has a throughput of at least about 2.33 Gbps, sufficient to support highly demanding environments.

The shared memory 112 of the kernel space 110 is established and accessed via the API 114. Specifically, the application 108 implements the API 114 to request kernel allocation of the shared memory 112 within the kernel 110. This is generally a contiguous memory segment. If this request is successful, the kernel 110 makes the shared memory 112 available immediately.

When a user space application 108 is available and active, incoming packets 102 are forwarded to the shared memory 112 by a packet capture process 106. Various proprietary or open source packet capture processes can be implemented in this regard including, for example, StillSecure Strata Guard. In the illustrated implementation, the incoming packets 102 are directed to the packet capture process 106, via a mandatory path 104. In particular the packets 102 may be received from a NIC driver via a primary kernel call, which may vary depending on the operating system employed. In this regard, the present invention may be implemented in connection with various proprietary or open source operating systems such as Microsoft Windows, MAC OS X and Linux. The kernel code can be extended to include a module option to enable in-line operation (e.g., set to 1 for in-line operation).

Upon receipt of a packet by the packet capture process 106, a determination is made as to whether a user space application 108 is available and active. In some implementations, this may involve custom interfaces for use by such applications 108 implemented via the PCAP library. Once this interface is used to indicate that a application 108 is available and active, the packet is forwarded to the shared memory 112. Otherwise, the packet may be either passed to the network stack 118 (fail open) or dropped (fail closed) based on a user-configurable setting. Again, the kernel code can be extended to include a module option for this setting (e.g., set to 1 for fail open or 0 for fail closed).

The user space application 108, when active, continually polls the shared memory 112 via API 114. In this manner, the application 108 directly inspects the new data. The inspection process depends on the nature of the application 108, but the application may, for example, search for patterns that should be removed or replaced (e.g., sensitive information such as social security numbers). If data that should be removed is found, it may be replaced with null data. If data is found that should be replaced that data is updated with new data. In this regard, if the new data would cause the packet to become fragmented (e.g., because the new data exceeds the Maximum Transit Unit or MTU), this may be detected by the application 108, which causes the new data to be spread over multiple data packets. That is, the current packet can be updated up to the limit of the MTU. A partial watch and replace can then be implemented on subsequent packet data.

If no data pattern is found that requires removal or replacement, the packet contents are left unaltered. In any case, the kernel 110 may be notified of the verdict (the result of the pass/no pass determination). In the case of a pass determination, the kernel 110 allows the packet (modified or otherwise) to continue into the network stack 118. Otherwise, the packet is dropped (e.g., the kernel de-allocates the associated memory cell).

Boundary conditions are properly banded by both the user space implementation library (PCAP) and the kernel space implementation. For example, upon the disconnect of the application 108, the shared memory 112 that was in use is properly turned down. If an additional application 108 (e.g., another interface of the same process) is still active, it will receive an adjusted load of packets. If no additional application 108 is active (e.g., the application under consideration in the last to exit), the remaining packets in the shared memory 112 can be processed in accordance with the current setting for use when no applications 108 are active (e.g., fail open or fail closed).

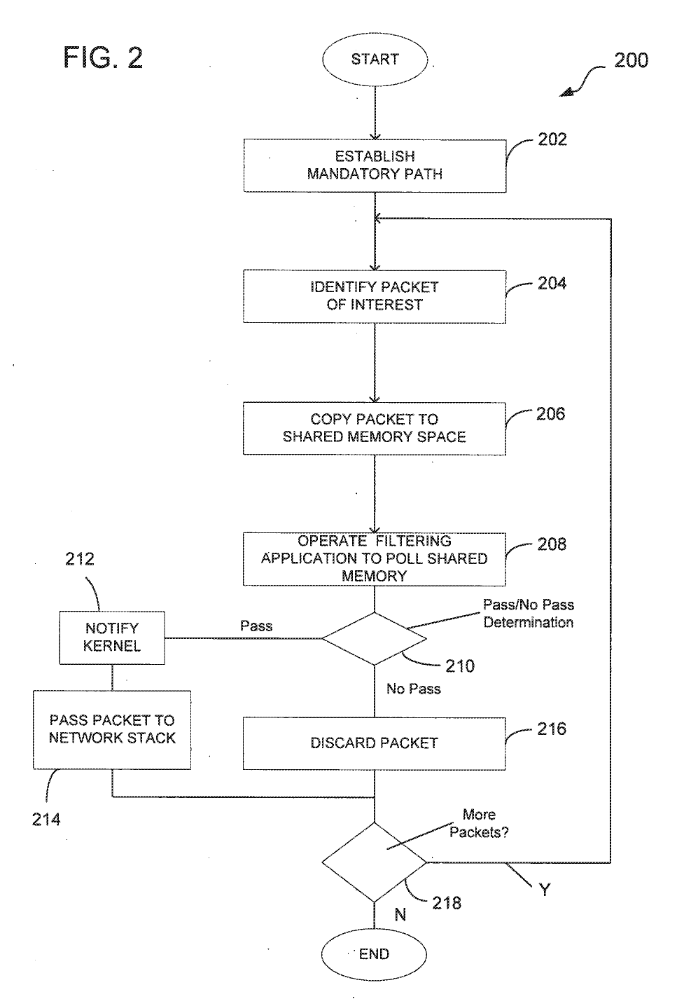

By way of summary, a corresponding traffic inspection and filtering process 200 is shown in FIG. 2. The process 200 is initiated 202 by establishing (202) a mandatory path through an appropriately configured packet capture process of a kernel for all (or a desired portion of) incoming and/or outgoing packets with respect to a protected interface. In this regard, the kernel module option noted above for enabling in-line operation can be set to the appropriate value. A packet of interest is then identified (204) and copied (206) to shared memory space of the kernel. In particular when the packet capture process is notified that a filtering application is available and active, incoming (and/or outgoing, depending on the configuration) packets may be mapped to a shared memory segment designated for that application.

The filtering application is then operated (208) to poll the shared memory segment. For example, such polling may be conducted continually via an API configured to enable access by the application to the designated kernel space memory. A pass/no pass (and/or data remove/replace) determination (210) is then made with respect to the packet by the application. In the case of a pass determination, the kernel is notified (212) (e.g., via populating a flag or field with a defined value) of the determination and the packet is passed (214) to the network stack. Otherwise, the packet is discarded or dropped (216), for example, by de-allocating the associated memory cell. This process continues until a determination is made (218) that there are no further packets for inspection (e.g., the application exits).

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for use in monitoring a network, comprising the steps of:
allocating a shared kernel memory segment of a kernel for access by a user space application;
using the allocated shared kernel memory segment to store packets for processing, in place in said shared kernel memory segment, by said user space application;
first operating the user space application to perform an analysis on at least a packet in the shared kernel memory segment; and
second operating said user space application to provide an output dependent on a result of said analysis.

2. The method as set forth in claim 1, wherein said step of allocating comprises receiving a request, from said user space application via an API, regarding allocation of said shared kernel memory segment and allocating said shared kernel memory segment responsive to said request.

3. The method as set forth in claim 1, wherein said step of using comprises monitoring a network interface and directing packets, associated with traffic across said interface, to said shared kernel memory segment.

4. The method as set forth in claim 1, wherein said step of first operating comprises repeatedly polling said shared kernel memory segment, for new data and performing said analysis on said new data.

5. The method as set forth in claim 1, wherein a result of said analysis is a PNP determination, and aid step of second operating comprises providing an output to said kernel indicating whether said packet should pass through a network stack.

6. The method as set forth in claim 1, wherein a result of said analysis is a PNP determination, and said method further comprises de-allocating a portion of shared kernel memory associated with said packet.

7. The method as set forth in claim 1, wherein said step of first operating comprises identifying content subject to a rule regarding transmission across a monitored interface.

8. The method as set forth in claim 7, further comprising modifying said packet based on said analysis.

9. The method as set forth in claim 8, wherein said step of modifying comprises one of removing and replacing said content.

10. An apparatus for use in monitoring a network, comprising:
a kernel including a shared kernel memory segment for access by a user space application;
an interface, associated with said kernel, for receiving packets for storage in said shared kernel memory segment for processing by said user space application; and
a processor operative for running said user space application to perform an analysis on at least a packet in the shared kernel memory segment and for operating said kernel to process said packet in a manner dependent on a result of said analysis.

11. An apparatus as set forth in claim 10, further comprising an API for use by said user space application in establishing and accessing said shared kernel memory segment.

12. An apparatus as set forth in claim 1, wherein said API is operative to allow said user space application to execute said analysis free from copying said at least one packet into user space memory.

13. An apparatus as set forth in claim 10, wherein a result of said analysis is a PNP determination and said processor operates said kernel to selectively pass said at least one packet through a network stack or drop said at least one packet based on said PNP determination.

14. A method for use in monitoring a network, comprising the steps of:
establishing a mandatory path for packet transmission in relation to a protected interface of the network, said mandatory path being implemented by a packet capture process of an operating system;
monitoring the mandatory path to identify a packet of interest for inspection by a user space process;
employing the user space process, free from copying the packet into user space to perform an analysis on the packet and make a pass/no pass (PNP) determination regarding the packet; and
operating the packet capture process to selectively allow or disallow the packet of interest to pass the protected interface of the network based on the PNP determination.

15. A method as set forth in claim 14, wherein said step of establishing comprises extending a packet capture process of a kernel to enable in-line operation of said user space process.

16. A method as set forth in claim 15, wherein said user space process comprises one of an IDS, an IPS and a network use policy enforcement process.

17. An apparatus for use in monitoring a network, comprising:
a packet capture module of an operating system configured to be a mandatory path for packet transmission in relation to a protected interface of the network;
a memory segment for storing a copy of a packet of interest from said packet capture module;
a user space inspection module for performing an analysis of said packet of interest of said memory segment so as to make a pass/no pass (PNP) determination regarding the packet; and
an interface for communicating a result of said PNP determination to said packet capture module, wherein said packet capture module can selectively allow or disallow the packet of interest to pass the protected interface of the network based on the PNP determination.

18. An apparatus as set forth in claim 17, wherein said memory segment is a kernel space memory segment.

19. An apparatus as set forth in claim 18, wherein said user space inspection module is operative for performing said analysis free from copying said packet of interest into user space memory.

20. A method for use in monitoring traffic across a network interface, comprising the steps of:
establishing a network connection with a computer having PC class hardware and a PC class operating system including a PC class kernel; and
operating said computer having said PC class hardware and said PC class operating system including said PC class kernel to filter traffic, across an interface between said computer and a network, on a packet-by-packet basis so as to implement a packet filtering determination with respect to the packets, said step of operating including filtering said traffic at a rate of at least about 200 MHz.

21. A method as set forth in claim 20, wherein said step of operating comprises filtering said traffic at a rate of at least 1 Gbps.

22. A method as set forth in claim 20, wherein said step of operating comprises executing a network analysis support module of said kernel for enhancing a throughput of traffic subject to said filtering.

23. A method as set forth in claim 22, wherein said network analysis support module is operative for establishing a segment of shared kernel memory segment by a user space application for executing said filtering.

24. An apparatus for use in monitoring a network, comprising:
an operating system running on a computer hardware system connected to a network said operating system including a kernel;
a user application for performing an analysis of network traffic, wherein said user application communicates with said kernel;
a network analysis support module of said kernel for facilitating said analysis of network traffic by said user application, wherein said network analysis support module enables a total throughput of network traffic subject to said analysis that is at least twice that which could be achieved said computer hardware system without said network analysis support module.

25. An apparatus as set forth in claim 24, wherein in said user application is one of an IDS, an IPS, and a network use policy enforcement process.

26. An apparatus as set forth in claim 24, further comprising a plurality of user applications for performing analyses of network traffic.

27. An apparatus as set forth in claim 26, further comprising at least one processor for running said user applications, wherein a total throughput of network traffic scales in a substantially linear way with a total number of said processors.
